(19) United States
(12) Patent Application Publication
(10) Pub. No.: US 2021/0339751 A1
(43) Pub. Date: Nov. 4, 2021

(54) VEHICLE AND DRIVE SYSTEM

(71) Applicant: SUBARU CORPORATION, Tokyo (JP)

(72) Inventors: Nozomu TERUNUMA, Tokyo (JP); Yoshiaki YUZAWA, Tokyo (JP); Shintaro KOZONO, Tokyo (JP); Masaki OOTA, Tokyo (JP); Hiroya OKADA, Tokyo (JP); Yutaka SATO, Tokyo (JP); Megumi FUSHIMI, Tokyo (JP)

(73) Assignee: SUBARU CORPORATION, Tokyo (JP)

(21) Appl. No.: 17/240,320

(22) Filed: Apr. 26, 2021

(30) Foreign Application Priority Data
Apr. 30, 2020 (JP) 2020-080792

(51) Int. Cl. B60W 40/06; G08G 1/00; B60W 30/09; B60W 30/095; B60W 30/02

(52) U.S. Cl. CPC B60W 40/06; G08G 1/22; B60W 2556/65; B60W 30/0956; B60W 30/02; B60W 30/09

(57) ABSTRACT

A vehicle includes a communicator, a road-surface abnormality determiner, and a driving controller. The communicator is configured to establish communication with a following vehicle following the vehicle driving ahead in a travel road. The road-surface abnormality determiner is configured to determine whether there is an abnormality on a road surface of the travel road, based on comparison between first driving information, serving as a reference to be used when the vehicle drives on the travel road, and second driving information detected as a result of the vehicle having actually driven. When the road-surface abnormality determiner determines that there is the abnormality, the driving controller is configured to predict whether the following vehicle is able to avoid the abnormality and to send an instruction to avoid the abnormality to the following vehicle via the communicator if the driving controller predicts that the following vehicle is able to avoid the abnormality.

### CROSS-REFERENCE TO RELATED APPLICATION

The present application claims priority from Japanese Patent Application No. 2020-080792 filed on Apr. 30, 2020, the entire contents of which are hereby incorporated by reference.

### BACKGROUND

The disclosure relates to a vehicle that is able to communicate with a different vehicle and also to a drive system.

A vehicle-to-vehicle communication technology for enabling plural vehicles to send and receive information with each other is available (see Japanese Unexamined Patent Application Publication No. 2019-142254, for example).

### SUMMARY

An aspect of the disclosure provides a vehicle including a communicator, a road-surface abnormality determiner, and a driving controller. The communicator is configured to establish communication with one or more different vehicles. The different vehicles include a following vehicle that follows the vehicle driving ahead in a travel road. The road-surface abnormality determiner is configured to determine whether there is an abnormality on a road surface of the travel road, on a basis of comparison between first driving information and second driving information. The first driving information serves as a reference to be used when the vehicle drives on the travel road. The second driving information is detected as a result of the vehicle having actually driven. In a case where the road-surface abnormality determiner determines that there is the abnormality, the driving controller is configured to predict whether the following vehicle is able to avoid the abnormality, and configured to send an instruction to avoid the abnormality to the following vehicle via the communicator if the driving controller predicts that the following vehicle is able to avoid the abnormality.

An aspect of the disclosure provides a drive system for use in a situation where a leading vehicle and a following vehicle that follows the leading vehicle drive on a travel road. The leading vehicle includes a first communicator, a road-surface abnormality determiner, and a first driving controller. The first communicator is configured to establish communication with the following vehicle. The road-surface abnormality determiner is configured to determine whether there is an abnormality on a road surface of the travel road, on a basis of comparison between first driving information and second driving information. The first driving information serves as a reference to be used when the leading vehicle drives on the travel road. The second driving information is detected as a result of the leading vehicle having actually driven. In a case where the road-surface abnormality determiner determines that there is the abnormality, the first driving controller is configured to predict whether the following vehicle is able to avoid the abnormality and configured to send an instruction to avoid the abnormality to the following vehicle via the first communicator if the first driving controller predicts that the following vehicle is able to avoid the abnormality. The following vehicle includes a second communicator, a driver, and a second driving controller. The second communicator is configured to establish communication with the leading vehicle. The driver is configured to drive left and right wheels at different levels of driving force. The second driving controller is configured to cause the driver to generate a difference in the driving force between the left and right wheels so as to avoid the abnormality, in response to the instruction to avoid the abnormality received from the leading vehicle via the second communicator.

An aspect of the disclosure provides a vehicle including a communicator and circuitry. The communicator is configured to establish communication with one or more different vehicles. The one or more different vehicles include a following vehicle that follows the vehicle driving ahead in a travel road. The circuitry is configured to determine whether there is an abnormality on a road surface of the travel road, on a basis of comparison between first driving information and second driving information. The first driving information serves as a reference to be used when the vehicle drives on the travel road. The second driving information is detected as a result of the vehicle having actually driven. In a case where it is determined that there is the abnormality, the circuitry is configured to predict whether the following vehicle following is able to avoid the abnormality. The circuitry is configured to send an instruction to avoid the abnormality to the following vehicle via the communicator if it is predicted that the following vehicle is able to avoid the abnormality.

An aspect of the disclosure provides a drive system for use in a situation where a leading vehicle and a following vehicle that follows the leading vehicle driving on a travel road. The leading vehicle includes a first communicator and first circuitry, and second circuitry. The first communicator is configured to establish communication with the following vehicle. The circuitry is configured to determine whether there is an abnormality on a road surface of the travel road, on a basis of comparison between first driving information and second driving information. The first driving information serves as a reference to be used when the leading vehicle drives on the travel road. The second driving information is detected as a result of the leading vehicle having actually driven. In a case where it is determined that there is the abnormality, the circuitry is configured to predict whether the following vehicle is able to avoid the abnormality, and send an instruction to avoid the abnormality to the following vehicle via the first communicator if it is predicted that the following vehicle is able to avoid the abnormality. The following vehicle includes a second communicator, a driver, and second circuitry. The second communicator is configured to establish communication with the leading vehicle. The driver is configured to drive left and right wheels at different levels of driving force. The second circuitry configured to cause the driver to generate a difference in the driving force between the left and right wheels so as to avoid the abnormality, in response to the instruction to avoid the abnormality received from the leading vehicle via the second communicator.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to explain the principles of the disclosure.

FIG. 1 illustrates an overview of a drive system according to a first embodiment of the disclosure;

FIG. 2 is a block diagram illustrating an example of the configuration of a leading vehicle;

FIG. 3 is a block diagram illustrating an example of the configuration of a following vehicle;

FIG. 4 is a flowchart illustrating processing executed by a road-surface abnormality determiner of the leading vehicle;

FIG. 5 is a flowchart illustrating prediction processing executed by a first driving controller of the leading vehicle;

FIG. 6 is a flowchart illustrating processing executed by a second driving controller of the following vehicle;

FIG. 7 illustrates an overview of a drive system according to a second embodiment of the disclosure;

FIG. 8 is a flowchart illustrating processing executed by a road-surface abnormality determiner of a vehicle driving ahead of the leading vehicle;

FIG. 9 is a flowchart illustrating an example of processing executed by the road-surface abnormality determiner of the leading vehicle;

FIG. 10 is a flowchart illustrating another example of processing executed by the road-surface abnormality determiner of the leading vehicle; and

FIG. 11 is a flowchart illustrating prediction processing executed by the first driving controller of the leading vehicle according to a third embodiment of the disclosure.

### DETAILED DESCRIPTION

An abnormality may occur on the road surface. For example, the road surface may become icy and slippery. It is desired that a vehicle suitably deal with such an abnormality while driving.

It is desirable to provide a vehicle and a drive system that are able to suitably deal with an abnormality on the road surface.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

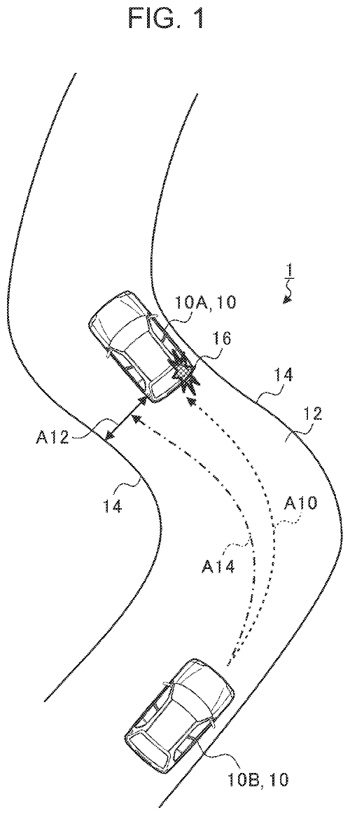

FIG. 1 illustrates an overview of a drive system 1 according to a first embodiment. The drive system 1 is applicable to a situation where multiple vehicles 10 drive on a traveling road 12 in a line with a distance therebetween. In the example illustrated in FIG. 1, among the multiple vehicles 10, a vehicle 10 running ahead may be called a leading vehicle 10A, while a vehicle 10 following the leading vehicle 10A may be called a following vehicle 10B. The leading vehicle 10A and the following vehicle 10B may collectively be called vehicles 10. The following vehicle 10B seen from the leading vehicle 10A may be called a different vehicle. The leading vehicle 10A seen from the following vehicle 10B may be called a different vehicle. The traveling road 12 includes a lane 12 corresponds to the area between left and right lane lines 14. Hereinafter, in this embodiment, the traveling road 12 is referred to as the lane 12.

In the example in FIG. 1, an abnormality 16 occurs in part of the road surface of the lane 12. The abnormality 16 may be the icy, slippery road surface. For example, the leading vehicle 10A has driven up onto the icy road surface while driving and the right rear wheel has slipped. In this case, if the following vehicle 10B takes the same path as the leading vehicle 10A, as indicated by the broken-line arrow A10 in FIG. 1, it is highly likely that the following vehicle 10B will slip on the abnormality 16 as in the leading vehicle 10A.

To deal with this situation, in the drive system 1, the leading vehicle 10A determines whether there is an abnormality 16 on the road surface. If the leading vehicle 10A has determined that there is an abnormality 16, it predicts whether the following vehicle 10B will be able to avoid the abnormality 16. This will be discussed later in detail. If, as indicated by the double-headed arrow A12 in FIG. 1, a space to avoid the abnormality 16, which may simply be called a space, is secured between the leading vehicle 10A and one lane line 14 (the left-side lane line 14, for example), the leading vehicle 10A predicts that the following vehicle 10B will be able to avoid the abnormality 16.

Then, the leading vehicle 10A sends an instruction to avoid the abnormality 16 to the following vehicle 10B. Upon receiving this instruction, the following vehicle 10B drives toward the space indicated by the double-headed arrow A12, as indicated by the long dashed dotted line A14 in FIG. 1. In one embodiment, the following vehicle 10B generates a difference in the driving force between the left and right wheels so as to change the route and drive toward the space as indicated by the long dashed dotted line A14.

In this manner, in the drive system 1, even when the leading vehicle 10A has failed to avoid the abnormality 16, it can let the following vehicle 10B suitably avoid the abnormality 16. As a result, an accident can be prevented on the lane 12, which may be a road with traffic. A vehicle 10 to be used in the drive system 1 will be discussed below in detail.

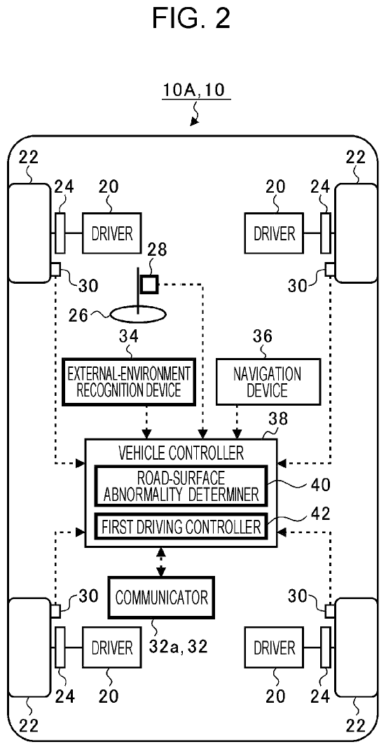

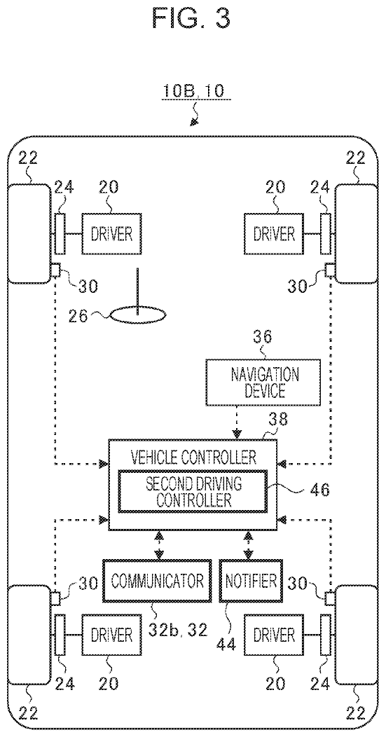

FIG. 2 is a block diagram illustrating an example of the configuration of the leading vehicle 10A. FIG. 3 is a block diagram illustrating an example of the configuration of the following vehicle 10B. In FIGS. 2 and 3, elements of the leading vehicle 10A and those of the following vehicle 10B different from each other are indicated by the blocks with bold lines. The leading vehicle 10A will be explained first with reference to FIG. 2, and then, the following vehicle 10B will be explained with reference to FIG. 3.

As illustrated in FIG. 2, the leading vehicle 10A includes drivers 20, wheels 22, braking mechanisms 24, a steering mechanism 26, a steering angle sensor 28, wheel speed sensors 30, a first communicator 32a, an external-environment recognition device 34, a navigation device 36, and a vehicle controller 38.

The driver 20 is a motor, for example, and is provided for each wheel 22. Each driver 20 generates driving force for the associated wheel 22. The drivers 20 are thus able to drive the left and right wheels 22 at different levels of driving force.

In the leading vehicle 10A, the driver 20 may not necessarily be provided for each wheel 22. The same driver 20 may drive the wheels 22. The driver 20 is not limited to a motor. That is, the leading vehicle 10A is not restricted to an electric automobile using a motor as a drive source, and may be an engine-powered automobile using an engine as a drive source or a hybrid electric automobile using an engine and a motor as a drive source.

The braking mechanisms 24 apply the brakes to the wheels 22. The steering mechanism 26 includes a steering wheel and changes the direction of the wheels 22 to turn the leading vehicle 10A.

The steering angle sensor 28 detects the steering angle of the steering mechanism 26. The wheel speed sensor 30 is provided for each wheel 22 and detects the rotational speed of the associated wheel 22 (wheel speed).

The first communicator 32a is able to communicate with the exterior of the leading vehicle 10A. For example, the first communicator 32a is able to establish wireless communication with a different vehicle, such as the following vehicle 10B, so as to perform vehicle-to-vehicle communication. The first communicator 32a can also perform communication via a communication network, such as the Internet. The first communicator 32a may indirectly communicate with a different vehicle, such as the following vehicle 10B, via a communication network, such as the Internet.

The external-environment recognition device 34 recognizes the environments outside the leading vehicle 10A. The external-environment recognition device 34 recognizes the environments in the traveling direction of the leading vehicle 10A, for example, based on an image captured by an imaging device. The external-environment recognition device 34 recognizes the lane lines 14 on the left and right sides of the lane 12, for example.

The navigation device 36 can obtain map information indicating a map and/or traffic information about traffic regulation, for example, via the first communicator 32a. The navigation device 36 includes an input/output function, such as a touchscreen display, and receives an input operation from a driver (a person driving the leading vehicle 10A) or a passenger and displays various items of information, such as map information and/or traffic information. The navigation device 36 can also obtain the current position of the leading vehicle 10A by using a global positioning system (GPS). The navigation device 36 can recognize the lane 12 by using map information, traffic information, the current position, or other information.

The vehicle controller 38 is constituted by a semiconductor integrated circuit including a central processing unit (CPU), a read only memory (ROM) storing a program therein, and a random access memory (RAM) serving as a work area, for example. The vehicle controller 38 controls the entirety of the leading vehicle 10A, such as the drivers 20, the braking mechanisms 24, and the steering mechanism 26, though a detailed explanation is omitted.

As a result of executing the program, the vehicle controller 38 serves as a road-surface abnormality determiner 40 and a first driving controller 42.

The road-surface abnormality determiner 40 determines whether there is an abnormality 16 on the road surface of the lane 12, based on comparison between first driving information and second driving information. The first driving information is a first steering angle, for example, which serves as a reference to be used when the leading vehicle 10A normally drives on the lane 12. The second driving information is a second steering angle, for example, detected as a result of the leading vehicle 10A having actually driven. The first driving information corresponds to a reference to be used to determine whether there is an abnormality 16 on the road surface. The first steering angle, which is an example of the first driving information, is a steering angle determined based on the radius of curvature of the lane 12 where the leading vehicle 10A is currently positioned, which is obtained from the map information and the current position. The second steering angle, which is an example of the second driving information, is a steering angle detected by the steering angle sensor 28. Specific processing executed by the road-surface abnormality determiner 40 will be discussed later.

If the road-surface abnormality determiner 40 has determined that there is an abnormality 16, the first driving controller 42 predicts whether the following vehicle 10B will be able to avoid the abnormality 16. If the first driving controller 42 predicts that the following vehicle 10B will be able to avoid the abnormality 16, it sends an instruction to avoid the abnormality 16 to the following vehicle 10B. If the first driving controller 42 predicts that the following vehicle 10B will not be able to avoid the abnormality 16, it sends an instruction to decelerate to the following vehicle 10B. Specific processing executed by the first driving controller 42 will be discussed later.

Regarding the following vehicle 10B, elements different from those of the leading vehicle 10A will be described while an explanation of elements configured similarly to those of the leading vehicle 10A will be omitted. As illustrated in FIG. 3, the following vehicle 10B includes drivers 20, wheels 22, braking mechanisms 24, a steering mechanism 26, wheel speed sensors 30, a second communicator 32b, a navigation device 36, a vehicle controller 38, and a notifier 44. The drivers 20, the wheels 22, the braking mechanisms 24, the steering mechanism 26, the wheel speed sensors 30, and the navigation device 36 are similar to those of the leading vehicle 10A.

The second communicator 32b is configured basically similarly to the first communicator 32a of the leading vehicle 10A, and is able to establish communication with the exterior of the following vehicle 10B. In one example, the second communicator 32b may communicate with the leading vehicle 10A, which is a different vehicle. Hereinafter, the first communicator 32a of the leading vehicle 10A and the second communicator 32b of the following vehicle 10B may collectively be called the communicator 32.

The drivers 20 of the following vehicle 10B drive the left and right wheels 22 at different levels of driving force.

The vehicle controller 38 of the following vehicle 10B serves as a second driving controller 46 as a result of executing a program.

In response to an instruction to avoid the abnormality 16 from the leading vehicle 10A, the second driving controller 46 causes the drivers 20 to generate a difference in the driving force between the left and right wheels 22 so as to avoid the abnormality 16. That is, the following vehicle 10B is capable of performing torque vectoring that can control the torque split ratio between the left and right wheels 22. Additionally, in response to an instruction to decelerate from the leading vehicle 10A, the second driving controller 46 causes the braking mechanisms 24 to automatically operate to slow down the following vehicle 10B. Specific processing executed by the second driving controller 46 will be discussed later.

The following vehicle 10B may include the steering angle sensor 28, the external-environment recognition device 34, and the first communicator 32a, as in the leading vehicle 10A. In the following vehicle 10B, the vehicle controller 38 may serve, not only as the second driving controller 46, but also as the road-surface abnormality determiner 40 and the first driving controller 42. The leading vehicle 10A may include the notifier 44 and the second communicator 32b, as in the following vehicle 10B. In the leading vehicle 10A, the vehicle controller 38 may serve, not only as the road-surface abnormality determiner 40 and the first driving controller 42, but also as the second driving controller 46.

The notifier 44 is an alarm lamp or a speaker, for example. When the following vehicle 10B takes some action to avoid the abnormality 16 or to decelerate in response to an instruction from the leading vehicle 10A, the notifier 44 issues this information. The notifier 44 may issue this information by causing the alarm lamp to emit light or blink or the speaker to emit sound.

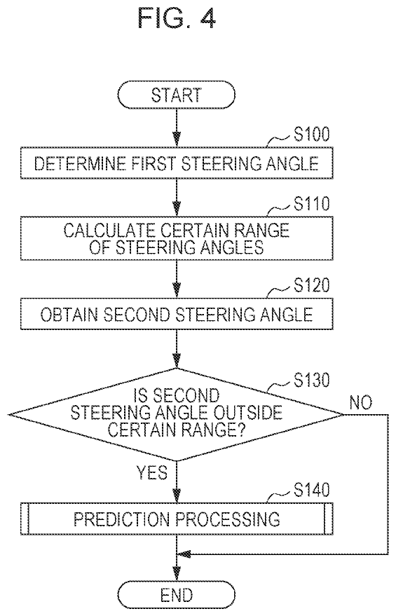

FIG. 4 is a flowchart illustrating processing executed by the road-surface abnormality determiner 40 of the leading vehicle 10A. The road-surface abnormality determiner 40 executes the processing indicated by the flowchart in FIG. 4 every time an interrupt timing arrives in a predetermined control cycle.

In step S100, the road-surface abnormality determiner 40 determines the first steering angle. In one example, the road-surface abnormality determiner 40 obtains map information and the current position of the leading vehicle 10A from the navigation device 36 and then determines the radius of curvature of the road surface at the current position, based on the map information and the current position. The road-surface abnormality determiner 40 then determines the normal steering angle at which the leading vehicle 10A runs (curves) on the road surface having the determined radius of curvature and sets this normal steering angle to be the first steering angle.

Then, in step S110, the road-surface abnormality determiner 40 calculates a certain range of steering angles by using the first steering angle. For example, the road-surface abnormality determiner 40 sets a normal distribution in which the first steering angle is used as the average (μ) and the variance (σ²) (where σ is a standard deviation) is a predetermined value. The road-surface abnormality determiner 40 then sets a range of the average (μ)±2σ (in other words, a range of the first steering angle±2σ) in the set normal distribution to be a certain range of steering angles. The certain range of steering angles is greater than or equal to (the first steering angle−2σ) and smaller than (the first steering angle+2σ).

Then, in step S120, the road-surface abnormality determiner 40 obtains the second steering angle from the steering angle sensor 28.

Then, in step S130, the road-surface abnormality determiner 40 determines whether the second steering angle is outside the certain range. In one example, if the second steering angle is smaller than (the first steering angle−2σ) or is greater than or equal to (the first steering angle+2σ), the road-surface abnormality determiner 40 determines that the second steering angle is outside the certain range.

If the second steering angle is found to be within the certain range (NO in step S130), the road-surface abnormality determiner 40 terminates the processing. If the second steering angle is found to be outside the certain range (YES in step S130), the road-surface abnormality determiner 40 determines that there is an abnormality 16 on the road surface and proceeds to prediction processing (S140) to predict whether the following vehicle 10B will be able to avoid the abnormality 16. The road-surface abnormality determiner 40 then completes the processing.

That is, if the actual steering angle (second steering angle) is different from the reference angle (first steering angle) by a large degree, it can be assumed that the driver (person driving the leading vehicle 10A) has turned the steering wheel by a large amount to avoid the abnormality 16. Hence, if the second steering angle is outside the certain range, the road-surface abnormality determiner 40 assumes that there is an abnormality 16 on the road surface and proceeds to prediction processing in step S140.

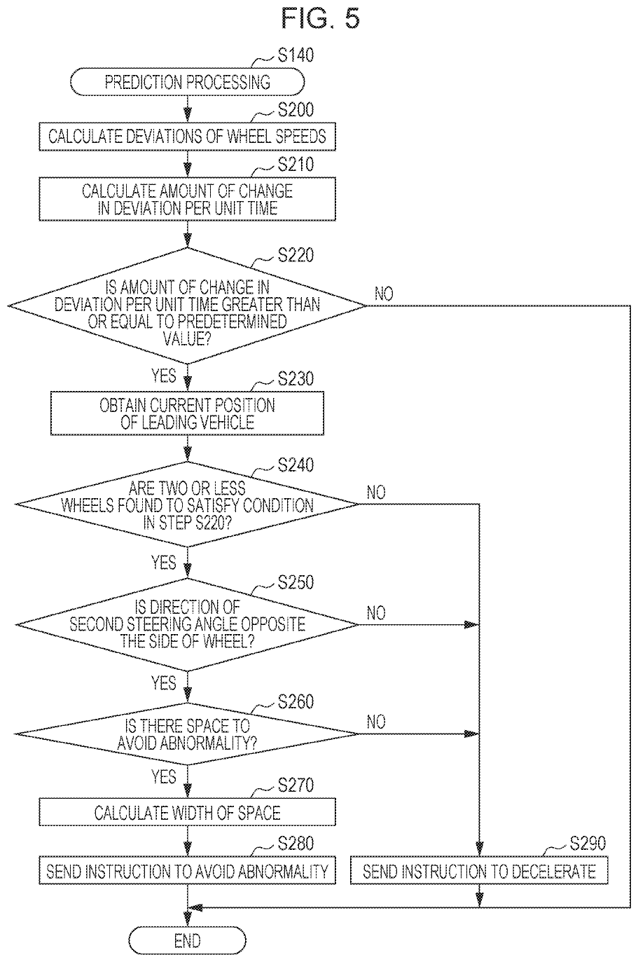

FIG. 5 is a flowchart illustrating prediction processing (S140) executed by the first driving controller 42. The first driving controller 42 constantly obtains the wheel speeds of the individual wheels 22 from the wheel speed sensors 30 and stores the obtained wheel speeds in a register, for example, regardless of the determination result of the road-surface abnormality determiner 40, namely, regardless of whether an abnormality 16 has been found.

In step S200, the first driving controller 42 calculates deviations of the wheel speeds of each wheel 22 by using the stored wheel speeds. The first driving controller 42 calculates a deviation of the wheel speed of each wheel 22 at a current (latest) time and that at a time prior to the current time by a predetermined period (for example, a time prior to the time when the abnormality 16 is found).

Deviations of the wheel speeds are calculated in the following manner. The first driving controller 42 finds the average of the wheel speeds of all the wheels 22 (four wheels) at the current time. The first driving controller 42 then divides the wheel speed of each wheel 22 at the current time by the average so as to determine the deviation of the wheel speed of each wheel 22 at the current time. That is, the deviation of the wheel speed of a wheel 22 is expressed by the ratio of the wheel speed of the wheel 22 to the average. The deviation of the wheel speed of each wheel 22 at a time prior to the current time is determined in a similar manner to the above-described approach to calculating the deviation of the wheel speed at the current time.

Then, in step S210, the first driving controller 42 calculates an amount of change in the deviation per unit time for each wheel 22. In one example, the first driving controller 42 calculates for each wheel 22 a difference between the deviation of the wheel speed at the current time and that at the time prior to the current time by the predetermined period as the amount of change in the deviation per unit time.

In step S220, the first driving controller 42 determines for each wheel 22 whether the amount of change in the deviation per unit time is greater than or equal to a predetermined value. That is, in step S220, the first driving controller 42 determines whether the rotational speed of each wheel 22 has soared. For example, if the leading vehicle 10A has run on the abnormality 16, which is a slippery road surface, the rotational speed of the wheel 22 passing on the abnormality 16 sharply rises. If, for a certain wheel 22, the amount of change in the deviation per unit time is greater than or equal to the predetermined value, it can be assumed that this wheel 22 has passed on the slippery abnormality 16.

If the amount of change in the deviation per unit time is smaller than the predetermined value for all the wheels 22 (NO in step S220), the first driving controller 42 assumes that the leading vehicle 10A has not run on the abnormality 16 and terminates the processing.

If the amount of change in the deviation per unit time is greater than or equal to the predetermined value for at least one wheel 22 (YES in step S220), the first driving controller 42 assumes that the leading vehicle 10A has run on the abnormality 16 and proceeds to step S230.

In step S230, the first driving controller 42 obtains the current position (current location) of the leading vehicle 10A from the navigation device 36. At a timing when the leading vehicle 10A has run on the abnormality 16, the position of the leading vehicle 10A overlaps at least part of the position of the abnormality 16. The current position of the leading vehicle 10A is obtained immediately after the leading vehicle 10A has run on the abnormality 16, and there is very little change in the position of the leading vehicle 10A with respect to that of the abnormality 16. The current position of the leading vehicle 10A obtained in step S230 is thus roughly the same as the position of the abnormality 16.

Then, in step S240, the first driving controller 42 determines whether the number of wheels 22 that satisfy the condition in step S220 (the amount of change in the deviation per unit time is greater than or equal to the predetermined value) is two or less. That is, in step S240, the size of the abnormality 16 is checked. If three or four wheels 22 are found to satisfy the condition in step S220, it can be assumed that the abnormality 16 spreads over between the left and right wheels 22 of the leading vehicle 10A. If one or two wheels 22 are found to satisfy the condition in step S220, it can be assumed that the abnormality 16 is restricted only to the left side or the right side of the leading vehicle 10A. If the left and right front wheels are found to satisfy the above-described condition, it is highly likely that the left and right back wheels also satisfy the condition. Hence, if the number of wheels 22 that satisfy the condition is two, it is less likely that the abnormality 16 spreads over between the left and right wheels 22.

If the number of wheels 22 that satisfy the condition in step S220 is two or less (YES in step S240), the first driving controller 42 determines in step S250 whether the direction of the second steering angle is opposite the side of the wheels 22 that are found to satisfy the condition in step S220.

In step S250, the first driving controller 42 determines on which of the left and right sides of the leading vehicle 10A the abnormality 16 is found. For example, if the abnormality 16 is located on the right side of the leading vehicle 10A, the driver (person driving the leading vehicle 10A) naturally steers to the left side to avoid the abnormality 16. That is, if the condition in step S250 is satisfied, the driver has taken some action to avoid the abnormality 16 and a space to avoid the abnormality 16 may be secured. In contrast, if the abnormality 16 is located on the right side of the leading vehicle 10A and if the driver has steered to the right side, it is assumed that the driver has not taken suitable action to avoid the abnormality 16. That is, if the condition in step S250 is not satisfied, it is highly likely that the driver has not tried to avoid the abnormality 16 and a space is not secured.

If the direction of the second steering angle is opposite the side of the wheels 22 that satisfy the condition in step S220 (YES in step S250), the first driving controller 42 determines in step S260 whether there is a space to avoid the abnormality 16. For example, if the direction of the second steering angle is on the left side and if the left side of the leading vehicle 10A is separated from the left lane line 14 by a certain distance, the first driving controller 42 determines that there is such a space. If the direction of the second steering angle is on the right side and if the right side of the leading vehicle 10A is separated from the right lane line 14 by a certain distance, the first driving controller 42 determines that there is such a space. That is, the first driving controller 42 can check for a space based on the width of the lane 12, the position of the leading vehicle 10A in the widthwise direction of the lane 12, and the width of the vehicle 10A.

If it is found that there is a space to avoid the abnormality 16 (YES in step S260), the first driving controller 42 determines the width of the space in step S270. For example, if the direction of the second steering angle is on the left side, the distance between the left lane line 14 and the left side surface of the leading vehicle 10A is the width of the space. If the direction of the second steering angle is on the right side, the distance between the right lane line 14 and the right side surface of the leading vehicle 10A is the width of the space.

Then, in step S280, the first driving controller 42 sends an instruction to avoid the abnormality 16 to the following vehicle 10B via the first communicator 32a and then completes the processing. The instruction includes, not only, information that the following vehicle 10B is to avoid the abnormality 16, but also the position of the leading vehicle 10A (namely, the position of the abnormality 16), the position of the lane line 14 on the side of the space, and the width of the space. Upon receiving this instruction, the following vehicle 10B drives toward the space to avoid the abnormality 16. As a result, the following vehicle 10B can avoid slipping on the abnormality 16.

If more than two wheels 22 are found to satisfy the condition in step S220 (NO in step S240), the first driving controller 42 assumes that the following vehicle 10B is unable to avoid the abnormality 16 because the abnormality 16 spreads over a wide range. Then, in step S290, the first driving controller 42 sends an instruction to decelerate to the following vehicle 10B via the first communicator 32a and then completes the processing. The instruction includes, not only information that the following vehicle 10B is to decelerate, but also the position of the leading vehicle 10A, namely, the position of the abnormality 16.

If it is found in step S250 that the direction of the second steering angle is the same as the side of the wheels 22 that satisfy the condition in step S220 (NO in step S250) or if it is found in step S260 that there is no space to avoid the abnormality 16 (NO in step S260), the first driving controller 42 also sends an instruction to decelerate to the following vehicle 10B in step S290. In response to this instruction, the following vehicle 10B slows down and passes on the abnormality 16 at a low speed even though it is unable to avoid the abnormality 16. The following vehicle 10B is thus less likely to slip on the abnormality 16.

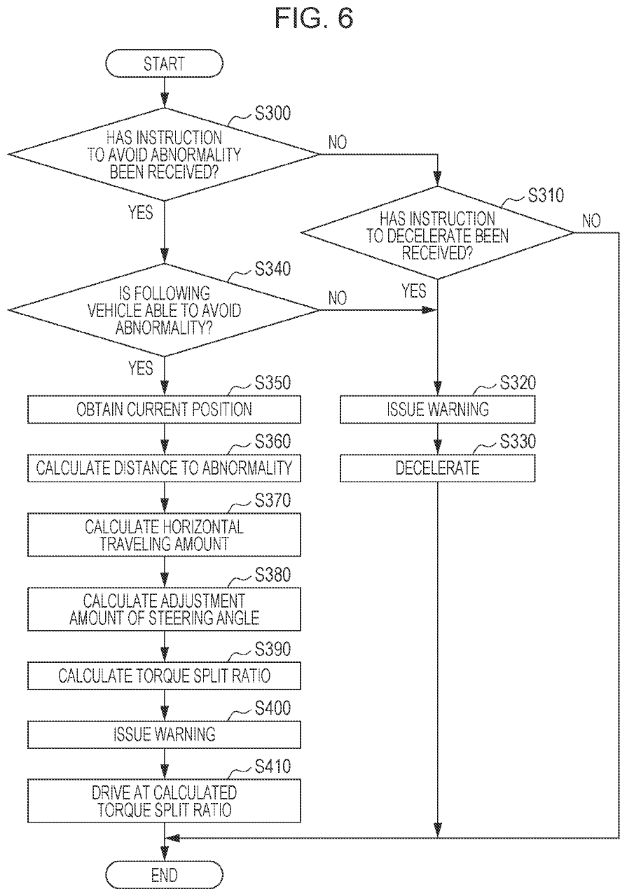

FIG. 6 is a flowchart illustrating processing executed by the second driving controller 46 of the following vehicle 10B. The second driving controller 46 executes the processing indicated by the flowchart in FIG. 6 every time an interrupt timing arrives in a predetermined control cycle.

In step S300, the second driving controller 46 determines whether an instruction to avoid the abnormality 16 has been received via the second communicator 32b. If such an instruction has not been received (NO in step S300), the second driving controller 46 determines in step S310 whether an instruction to decelerate has been received. If such an instruction has not been received (NO in step S310), the second driving controller 46 terminates the processing and enters a standby state.

If an instruction to decelerate has been received (YES in step S310), the second driving controller 46 causes the notifier 44 to issue a warning that the abnormality 16 is found in step S320. Then, in step S330, the second driving controller 46 causes the braking mechanisms 24 to automatically operate to slow down the following vehicle 10B and then completes the processing.

If an instruction to avoid the abnormality 16 has been received (YES in step S300), the second driving controller 46 determines in step S340 whether the following vehicle 10B is able to avoid the abnormality 16. In one example, if the width of the following vehicle 10B is smaller than the space, the second driving controller 46 determines that the following vehicle 10B is able to avoid the abnormality 16. If the width of the following vehicle 10B is greater than or equal to the space, the second driving controller 46 determines that the following vehicle 10B is unable to avoid the abnormality 16.

If it is found that the following vehicle 10B is unable to avoid the abnormality 16 (NO in step S340), the second driving controller 46 proceeds to step S320 to cause the notifier 44 to issue a warning that the abnormality 16 is found and further to step S330 to cause the following vehicle 10B to decelerate. The second driving controller 46 then completes the processing.

If it is found in step S340 that the following vehicle 10B is able to avoid the abnormality 16, the second driving controller 46 obtains the current position of the following vehicle 10B from the navigation device 36 in step S350. Then, in step S360, the second driving controller 46 calculates the distance to the abnormality 16 on the lane 12, based on the current position of the following vehicle 10B, the position of the leading vehicle 10A (the position of the abnormality 16), and map information.

In step S370, based on the position and the width of the space, the second driving controller 46 calculates an amount by which the following vehicle 10B is to travel horizontally, namely, in the widthwise direction of the lane 12, so as to avoid the abnormality 16. Such an amount will be called the horizontal traveling amount. Then, in step S380, the second driving controller 46 calculates an amount by which the steering angle will be adjusted to avoid the abnormality 16 (such an amount will be called the adjustment amount of the steering angle), based on the distance to the abnormality 16 and the horizontal traveling amount.

In step S390, the second driving controller 46 calculates the torque split ratio between the left and right wheels 22 so as to cause the following vehicle 10B to turn by the adjustment amount of the steering angle. Then, in step S400, the second driving controller 46 causes the notifier 44 to issue a warning that the abnormality 16 is found. In step S410, the second driving controller 46 causes the drivers 20 to drive the left and right wheels 22 at the torque split ratio calculated in step S390 and then completes the processing.

The following vehicle 10B then drives along the path based on the torque split ratio so as to avoid the abnormality 16. For example, if the space to avoid the abnormality 16 is located on the left side of the lane 12 in the widthwise direction, as in the example in FIG. 1, the second driving controller 46 calculates torque (driving force) to be applied to the right wheel 22 to be greater than that to the left wheel 22. Then, the following vehicle 10B can turn to the left side by a larger amount, as indicated by the long dashed dotted line A14 in FIG. 1.

As described above, in the first embodiment, if it is determined that there is an abnormality 16 on the road surface, the first driving controller 42 of the leading vehicle 10A predicts whether the following vehicle 10B will be able to avoid the abnormality 16. If the first driving controller 42 predicts that the following vehicle 10B will be able to avoid the abnormality 16, it sends an instruction to avoid the abnormality 16 to the following vehicle 10B. If the first driving controller 42 predicts that the following vehicle 10B will not be able to avoid the abnormality 16, it sends an instruction to decelerate to the following vehicle 10B.

As a result, the following vehicle 10B can avoid the abnormality 16 or slow down when passing on the abnormality 16. In this manner, the leading vehicle 10A of the first embodiment is able to suitably deal with the abnormality 16 on the road surface.

In the first embodiment, the road-surface abnormality determiner 40 checks for an abnormality 16 on the road surface, based on comparison between the first steering angle determined from map information and the second steering angle detected by the steering angle sensor 28. If, however, the actual lane 12 is different from the map information, which serves as a basis for determining the first steering angle, it may not be possible to check for an abnormality 16 correctly. In a second embodiment, another approach is taken to check for an abnormality 16.

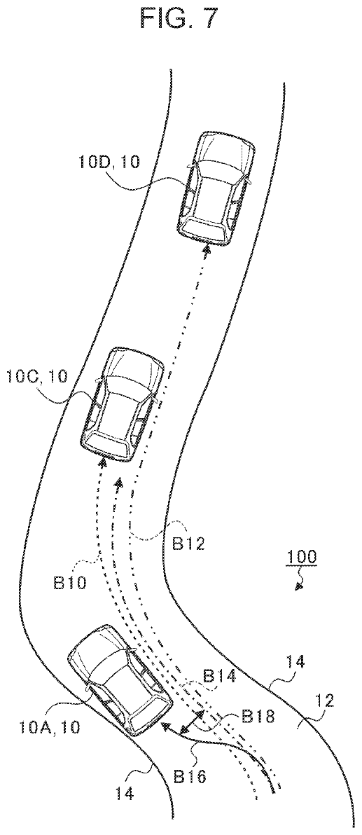

FIG. 7 illustrates an overview of a drive system 100 according to a second embodiment. In the example in FIG. 7, leading vehicles 10C and 10D are running on the lane 12 ahead of the leading vehicle 10A discussed in the first embodiment. The leading vehicles 10A, 10C, and 10D may collectively be called vehicles 10. For the sake of convenience, the second embodiment will be discussed, assuming that two vehicles, that is, the leading vehicles 10C and 10D, are running ahead of the leading vehicle 10A. However, the drive system 100 is applicable to a situation where three or more vehicles 10 run ahead of the leading vehicle 10A.

While driving on the lane 12, each vehicle 10 calculates current drive path information associated with the current position of the vehicle 10. The drive path information indicates the position of the vehicle 10 in the widthwise direction of the lane 12.

In FIG. 7, the broken-line arrow B10 indicates a history of the drive path information of the leading vehicle 10C, which is one ahead of the leading vehicle 10A. The long-dashed-double-dotted-line arrow B12 indicates a history of the drive path information of the leading vehicle 10D, which is one ahead of the leading vehicle 10C. Such drive path information is sequentially sent from a leading vehicle 10 to a following vehicle 10. For example, the leading vehicle 10A receives and stores the drive path information of the leading vehicle 10C and that of the leading vehicle 10D that are running ahead of the leading vehicle 10A.

The long-dashed-dotted-line arrow B14 in FIG. 7 indicates the transition of drive path information obtained by averaging the drive path information of the leading vehicle 10C and that of the leading vehicle 10D, that is, by averaging each of the positions of the leading vehicle 10C in the traveling direction on the lane 12 and the associated positions of the leading vehicle 10D. Although the two items of drive path information is averaged for the sake of convenience, the number of items of drive path information to be averaged may be determined in accordance with the traffic on the lane 12. The average of plural items of drive path information calculated in this manner reflects the actual situation of the lane 12.

The solid-line arrow B16 in FIG. 7 indicates a history of the drive path information of the leading vehicle 10A. The leading vehicle 10A checks for an abnormality 16, based on comparison between the above-described averaged drive path information and the drive path information of the leading vehicle 10A. For example, if the drive path information of the leading vehicle 10A deviates from the averaged drive path information by a large amount, as indicated by the double-headed arrow B18 in FIG. 7, the leading vehicle 10A may have taken action to avoid an abnormality 16.

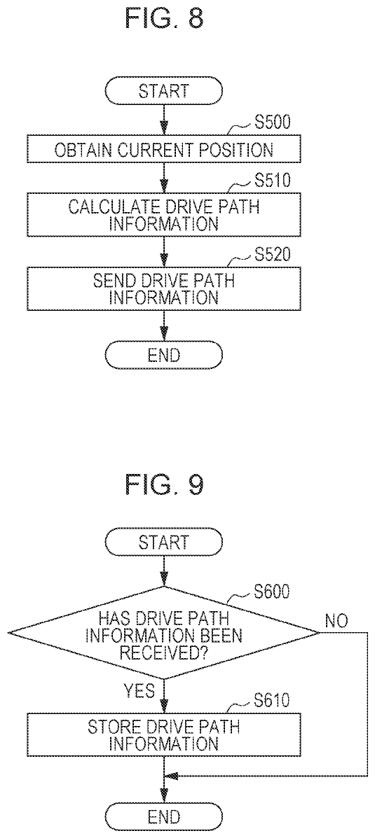

FIG. 8 is a flowchart illustrating processing executed by the road-surface abnormality determiner 40 of a vehicle (the leading vehicle 10C, for example) ahead of the leading vehicle 10A. The road-surface abnormality determiner 40 of the leading vehicle 10C executes the processing indicated by the flowchart in FIG. 8 every time an interrupt timing arrives in a predetermined control cycle.

In step S500, the road-surface abnormality determiner 40 of the leading vehicle 10C obtains the current position of the leading vehicle 10C from the navigation device 36.

Then, in step S510, the road-surface abnormality determiner 40 calculates drive path information indicating the position of the leading vehicle 10C in the widthwise direction of the lane 12, based on the left and right lane lines 14 recognized by the external-environment recognition device 34. Then, in step S520, the road-surface abnormality determiner 40 associates the calculated drive path information with the current position of the leading vehicle 10C and then sends the drive path information to a vehicle following the leading vehicle 10C (leading vehicle 10A, for example). The road-surface abnormality determiner 40 then completes the processing. Another leading vehicle 10, such as the leading vehicle 10D, also executes processing similarly to the leading vehicle 10C.

FIG. 9 is a flowchart illustrating an example of processing executed by the road-surface abnormality determiner 40 of the leading vehicle 10A. In step S600, the road-surface abnormality determiner 40 of the leading vehicle 10A determines whether drive path information has been received from a vehicle 10 (the leading vehicle 10C, for example) ahead of the leading vehicle 10A. If drive path information has been received (YES in step S600), the road-surface abnormality determiner 40 stores it in a register, for example, in step S610. The leading vehicle 10A stores items of drive path information of a predetermined number of vehicles 10 ahead of the leading vehicle 10A. The leading vehicle 10A may alternatively store items of drive path information of plural vehicles 10 which have passed the current position of the leading vehicle 10A during a predetermined period back from the current time.

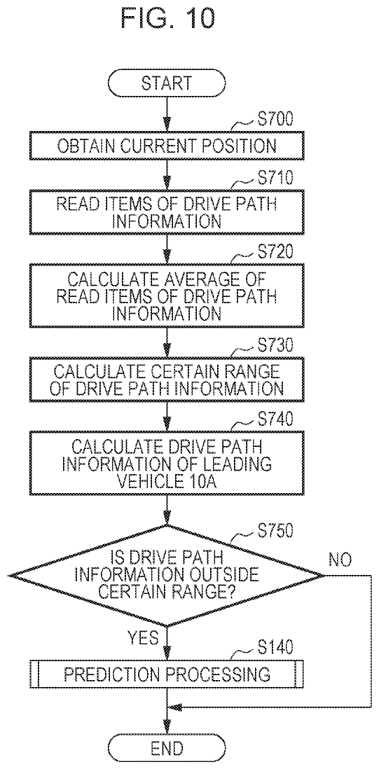

FIG. 10 is a flowchart illustrating another example of processing executed by the road-surface abnormality determiner 40 of the leading vehicle 10A. In FIG. 10, steps different from those in FIG. 4 are indicated by the blocks with bold lines. The road-surface abnormality determiner 40 of the leading vehicle 10A executes the processing indicated by the flowchart in FIG. 10 every time an interrupt timing arrives in a predetermined control cycle.

In step S700, the road-surface abnormality determiner 40 first obtains the current position of the leading vehicle 10A from the navigation device 36. Then, in step S710, the road-surface abnormality determiner 40 reads items of drive path information corresponding to the current position obtained in step S700 among the stored items of drive path information obtained from the leading vehicles 10C and 10D ahead of the leading vehicle 10A.

In step S720, the road-surface abnormality determiner 40 calculates the average of the read items of drive path information. Then, in step S730, the road-surface abnormality determiner 40 calculates a certain range of drive path information. For example, the road-surface abnormality determiner 40 sets a normal distribution in which the average calculated in step S720 is used as the average of the normal distribution and the variance (σ²) (where σ is a standard deviation) is a predetermined value. The road-surface abnormality determiner 40 then determines a range of the average±2σ in the set normal distribution to be a certain range of drive path information. The certain range of drive path information is greater than or equal to (the average−2σ) and smaller than (the average+2σ).

Then, in step S740, the road-surface abnormality determiner 40 calculates drive path information indicating the position of the leading vehicle 10A in the widthwise direction of the lane 12, based on the left and right lane lines 14 recognized by the external-environment recognition device 34.

Then, in step S750, the road-surface abnormality determiner 40 determines whether the drive path information calculated in step S740 is outside the certain range calculated in step S730. In one example, if the drive path information is smaller than (the average−2σ) or is greater than or equal to (the average+2σ), the road-surface abnormality determiner 40 determines that the drive path information is outside the certain range.

If the drive path information is found to be within the certain range (NO in step S750), the road-surface abnormality determiner 40 terminates the processing. If the drive path information is found to be outside the certain range (YES in step S750), the road-surface abnormality determiner 40 proceeds to prediction processing (S140) and then completes the processing.

As described above, in the second embodiment, the road-surface abnormality determiner 40 of the leading vehicle 10A calculates the average of items of drive path information obtained as a result of vehicles 10 ahead of the leading vehicle 10A having actually driven on the lane 12 and then sets the calculated average as first driving information, which serves as reference information. The road-surface abnormality determiner 40 sets drive path information obtained as a result of the leading vehicle 10A having actually driven on the lane 12 as second driving information, which serves as detected information. Then, the road-surface abnormality determiner 40 determines whether there is an abnormality 16 on the road surface, based on comparison between the first driving information and the second driving information.

With this configuration, in the second embodiment, even if there is a difference between map information and the actual lane 12, the leading vehicle 10A can determine the presence of an abnormality 16 more accurately in accordance with the actual lane 12. As a result, prediction processing can be executed at a more accurate timing, and an instruction to avoid the abnormality 16 or to decelerate can be sent to the following vehicle 10B at a more suitable timing.

In prediction processing in the first embodiment, if the following vehicle 10B is predicted to be able to avoid the abnormality 16, the leading vehicle 10A sends an instruction to avoid the abnormality 16, and if the following vehicle 10B is predicted to be unable to avoid the abnormality 16, the leading vehicle 10A sends an instruction to decelerate. Upon receiving the instruction to decelerate, the following vehicle 10B slows down to drive on the abnormality 16 and is thus less likely to slip on the abnormality 16.

If, however, the following vehicle 10B drives on the abnormality 16 with an increased steering angle, it may slip on the abnormality 16 depending on the situation. To deal with such a situation, in a third embodiment, it makes it even less likely for the following vehicle 10B to slip on the abnormality 16.

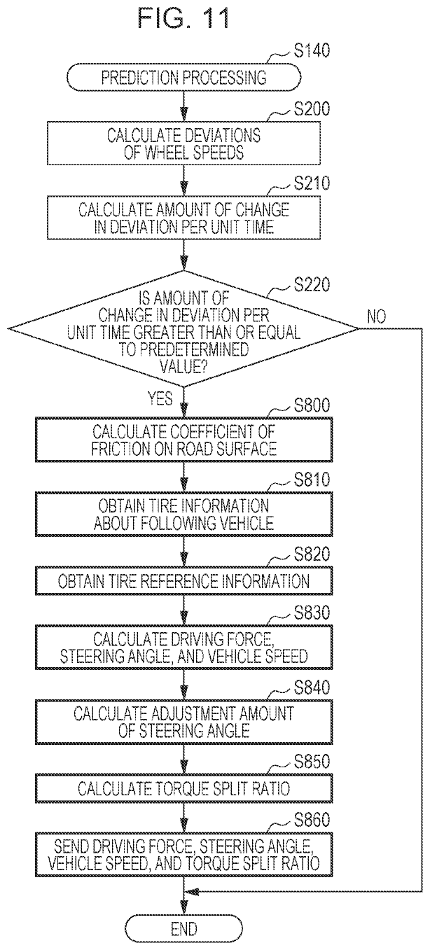

FIG. 11 is a flowchart illustrating prediction processing in step S140 executed by the first driving controller 42 of the leading vehicle 10A according to the third embodiment. In FIG. 11, steps different from those in FIG. 5 are indicated by the blocks with bold lines.

If the amount of change in the deviation per unit time is greater than or equal to the predetermined value for at least one wheel 22 (YES in step S220), that is, if the leading vehicle 10A has driven on the abnormality 16, the first driving controller 42 calculates a coefficient of friction (μ) on the road surface in step S800. The calculated coefficient of friction corresponds to that on the road surface of the abnormality 16 where the wheel 22 of the leading vehicle 10A has slipped.

In step S810, the first driving controller 42 communicates with the following vehicle 10B via the communicator 32 and obtains tire information about the following vehicle 10B. The tire information includes tire type (model) information and tire wear information about the wear (degradation) of tires.

The tire wear information corresponds to a slope representing the relationship between the slip ratio and the driving force that are roughly proportional to each other.

As the tire wears away, this slope becomes gentler. For example, the following vehicle 10B calculates the slip ratio to the driving force on a regular basis and stores it as tire wear information about the following vehicle 10B. This enables the first driving controller 42 to obtain the latest tire wear information from the following vehicle 10B.

Then, in step S820, the first driving controller 42 obtains tire reference information concerning the tire model of the following vehicle 10B from a tire manufacturer, for example, via the communicator 32. The tire reference information corresponds to a slope representing the relationship between the slip ratio and the driving force of the tire when it is new just shipped from the manufacturer, for example.

The tire information and tire reference information about the following vehicle 10B may not necessarily be obtained at timings of steps S810 and S820. The first driving controller 42 may obtain the tire information and tire reference information about the following vehicle 10B on a regular basis before checking the presence of an abnormality 16.

Then, in step S830, based on the difference (degradation degree of the tire) between the tire reference information and the tire wear information and the coefficient of friction (μ) on the road surface, the first driving controller 42 calculates the driving force and the steering angle that may not cause the following vehicle 10B to slip on the road surface having the coefficient of friction (μ) calculated in step S800, and then calculates the vehicle speed from the driving force.

The coefficient of friction (μ) on the road surface and the driving force are roughly proportional to each other. As the degradation degree of a tire and the steering angle become larger, the slope representing the relationship between the coefficient of friction (μ) and the driving force becomes gentler. Hence, a suitable combination of the driving force and the steering angle is determined based on the coefficient of friction on the road surface and the degradation degree of the tire at the current time. That is, a suitable combination of the driving force and the steering angle that may not cause the following vehicle 10B to slip on the abnormality 16 having the coefficient of friction calculated in step S800 is determined.

Then, in step S840, the first driving controller 42 obtains the current position of the following vehicle 10B, and calculates an adjustment amount of the steering angle to be added to the steering angle calculated in step S830 so as to allow the following vehicle 10B to drive from the current position to the position of the leading vehicle 10A.

Then, in step S850, the first driving controller 42 calculates the torque split ratio between the left and right wheels 22 corresponding to the adjustment amount of the steering angle. That is, the steering angle calculated in step S830 may not be large enough to allow the following vehicle 10B to drive on the lane 12, and an insufficient amount of the steering angle is compensated for by the torque split ratio between the left and right wheels 22 so as to allow the following vehicle 10B to suitably turn on the lane 12.

In step S860, the first driving controller 42 sends the calculated driving force, steering angle, vehicle speed, and torque split ratio to the following vehicle 10B and completes the processing. The following vehicle 10B then drives in accordance with the driving force, steering angle, vehicle speed, and torque split ratio received from the leading vehicle 10A.

As described above, in the third embodiment, even when the following vehicle 10B runs on the abnormality 16, it is less likely to slip because the driving force, steering angle, and vehicle speed are smaller than those corresponding to the coefficient of friction on the road surface of the abnormality 16. Additionally, the torque split ratio between the left and right wheels 22 is calculated and applied so as to allow the following vehicle 10B to turn suitably even with a small steering angle.

In the third embodiment, the first driving controller 42 may also determine whether the following vehicle 10B will be able to avoid the abnormality 16. If the following vehicle 10B is found to be capable of avoiding the abnormality 16, the first driving controller 42 may send an instruction to avoid the abnormality 16 to the following vehicle 10B, instead of sending the driving force, steering angle, vehicle speed, and torque split ratio in step S860.

The disclosure has been discussed through illustration of the embodiments with reference to the accompanying drawings. However, the disclosure is not restricted to these embodiments. Obviously, many modifications and variations will be apparent to practitioners skilled in the art without departing from the scope and spirit of the disclosure, and it is understood that such modifications and variations are also encompassed in the technical scope of the disclosure.

For example, at least part of the processing executed by the first driving controller 42 of the leading vehicle 10A and at least part of the processing executed by the second driving controller 46 of the following vehicle 10B may be executed by a server on a network to be connected to the communicator 32. In this case, the server may obtain various items of information to be used for executing processing from vehicles 10, for example.

The vehicle controller 38 illustrated in FIG. 2 and that in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the vehicle controller 38 including the road-surface abnormality determiner 40 and the first driving controller 42 and the vehicle controller 38 including the second driving controller 46. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIGS. 2 and 3.

1. A vehicle comprising:
a communicator configured to establish communication with one or more different vehicles, the one or more different vehicles comprising a following vehicle that follows the vehicle driving ahead in a travel road;
a road-surface abnormality determiner configured to determine whether there is an abnormality on a road surface of the travel road, on a basis of comparison between first driving information and second driving information, the first driving information serving as a reference to be used when the vehicle drives on the travel road, the second driving information being detected as a result of the vehicle having actually driven; and
a driving controller configured to, in a case where the road-surface abnormality determiner determines that there is the abnormality, predict whether the following vehicle is able to avoid the abnormality, and configured to send an instruction to avoid the abnormality to the following vehicle via the communicator if the driving controller predicts that the following vehicle is able to avoid the abnormality.

2. The vehicle according to claim 1, wherein, if the driving controller predicts that the following vehicle is not able to avoid the abnormality, the driving controller sends an instruction to decelerate to the following vehicle.

3. A drive system for use in a situation where a leading vehicle and a following vehicle that follows the leading vehicle driving on a travel road,
the leading vehicle comprising:
a first communicator configured to establish communication with the following vehicle;
a road-surface abnormality determiner configured to determine whether there is an abnormality on a road surface of the travel road, on a basis of comparison between first driving information and second driving information, the first driving information serving as a reference to be used when the leading vehicle drives on the travel road, the second driving information being detected as a result of the leading vehicle having actually driven; and
a first driving controller configured, in a case where the road-surface abnormality determiner determines that there is the abnormality, to predict whether the following vehicle is able to avoid the abnormality and configured to send an instruction to avoid the abnormality to the following vehicle via the first communicator if the first driving controller predicts that the following vehicle is able to avoid the abnormality,
the following vehicle comprising:
a second communicator configured to establish communication with the leading vehicle;
a driver configured to drive left and right wheels at different levels of driving force; and
a second driving controller configured to cause the driver to generate a difference in the driving force between the left and right wheels so as to avoid the abnormality, in response to the instruction to avoid the abnormality received from the leading vehicle via the second communicator.

4. A vehicle comprising:
a communicator configured to establish communication with one or more different vehicles, the one or more different vehicles comprising a following vehicle that follows the vehicle driving ahead in a travel road; and
circuitry configured to
determine whether there is an abnormality on a road surface of the travel road, on a basis of comparison between first driving information and second driving information, the first driving information serving as a reference to be used when the vehicle drives on the travel road, the second driving information being detected as a result of the vehicle having actually driven,
in a case where it is determined that there is the abnormality, predict whether the following vehicle is able to avoid the abnormality, and
send an instruction to avoid the abnormality to the following vehicle via the communicator if it is predicted that the following vehicle is able to avoid the abnormality.

5. A drive system for use in a situation where a leading vehicle and a following vehicle that follows the leading vehicle driving on a travel road,
the leading vehicle comprising:
a first communicator configured to establish communication with the following vehicle; and
first circuitry configured to
determine whether there is an abnormality on a road surface of the travel road, on a basis of comparison between first driving information and second driving information, the first driving information serving as a reference to be used when the leading vehicle drives on the travel road, the second driving information being detected as a result of the leading vehicle having actually driven,
in a case where it is determined that there is the abnormality, predict whether the following vehicle is able to avoid the abnormality, and
send an instruction to avoid the abnormality to the following vehicle via the first communicator if it is predicted that the following vehicle is able to avoid the abnormality,
the following vehicle comprising:
a second communicator configured to establish communication with the leading vehicle;
a driver configured to drive left and right wheels at different levels of driving force; and
second circuitry configured to
cause the driver to generate a difference in the driving force between the left and right wheels so as to avoid the abnormality, in response to the instruction to avoid the abnormality received from the leading vehicle via the second communicator.
